(19) United States
(12) Patent Application Publication
(10) Pub. No.: US 2020/0205417 A1
(43) Pub. Date: Jul. 2, 2020

(54) MICROALGAE EXTRACT FOR AGRICULTURAL USE

(71) Applicant: Guido EMILIANI, Lugo (RA) (IT)

(72) Inventor: Guido EMILIANI, Lugo (RA) (IT)

(21) Appl. No.: 16/799,042

(22) Filed: Feb. 24, 2020

Related U.S. Application Data
(63) Continuation of application No. 16/374,275, filed on Apr. 3, 2019, now abandoned.
Application No. 16/374,275 is a continuation of application No. 15/569,406, filed on Oct. 26, 2017, now abandoned.

(30) Foreign Application Priority Data
Apr. 30, 2015 (IT) BO2015A000217

(51) Int. Cl. A01N 65/03; A01N 43/16; A01N 63/10

(52) U.S. Cl. CPC A01N 65/03; A01N 63/10; A01N 43/16

(57) ABSTRACT

A composition for agricultural use that includes a biotic compound derived from microalgae, the compound being capable of causing the induction of resistance in plants. The microalgae may be diatoms and/or cyanobacteria. In particular, they may include an algal strain selected from the group of Phaeodactylum tricornutum, Arthrospira platensis (Spirulina), Euglena gracilis and Porphyridium cruentum.

This is a continuation of U.S. Ser. No. 16/374,275, filed Apr. 3, 2019, which is a continuation of U.S. Ser. No. 15/569,406, filed Oct. 26, 2017, which is the National Stage of International Application No. PCT/IB2016/052477, with an International filing date of May 2, 2016 (with a priority date of Apr. 30, 2015), the disclosures of which are hereby incorporated by reference in their entireties into this application.

The present invention relates to a novel composition for agricultural use, and to its use in the treatment of plants and crops.

The invention relates to the field of controlling plant disease by resistance induction. In the context of this field, the invention aims to induce resistance against pathogens through the administration of natural substances or substances of natural origin.

The mechanisms of resistance induction in plants have been examined in depth both scientifically and experimentally. The ability of plants to protect themselves against phytopathogens can derive from Systemic Acquired Resistance (SAR), where the entire plant is able to prepare itself for future attacks by pathogens. The time required for the plant to put systemic resistance mechanisms in place depends both on the species and on the inducing pathogen. However, some reactions developed naturally by the plant are not sufficiently rapid to prevent swift dissemination and colonisation by the pathogen. A synthetic plant protection product specifically registered as an activator of plant defences is known, based on acibezolar-S-methyl and known by the trade name of BION, made by Syngenta. However, this product poses various hazards to human health and the environment, including the fact that it is an irritant and causes long-term adverse effects for the aquatic environment.

The intrinsic non-neutrality of synthetic resistance inductors with respect to the environment has encouraged the study, especially in the last ten years, of natural compounds or compounds of natural origin capable of triggering biochemical mechanisms in the plant that confer a certain resistance to particular phytopathogens. Studies are being made of inductors of various types and origins, including abiotic, fungal, bacterial and plant-derived inductive substances. Trials are known of resistance inductors based on Solidago canadensis (CanG), extract of mycelium of Penicillium crysogenum (PEN), linoleic acid (LIN), and Aureobasidium pullulans (Aureo), as well as the chemical elicitors 3-dl-β-aminobutyric acid (BABA) and benzothiadiazole (BTH). The chemical nature of these substances is highly varied, but in general they are polysaccharides, lipids or proteins. For example, the role of the lipopolysaccharides in the induction of plant defence responses is known scientifically (Gitte Erbs et al., Role of lipopolysaccharides in induction of plant defense responses, Molecular Plant Pathology (2003) 4(5), 421-425). The following have recently been mentioned among the plant metabolites currently being studied and trialled with a view to the induction of SAR effects on plants (Bugiani Riccardo 24 Mar. 2013): salicylic acid, linoleic acid, galacturonic acid, m-hydroxybenzoic acid, jasmonates (including jasmonic acid and methyl jasmonate), laminarine (selected extracts of macroalgae), extracts of ivy (Hedera helix), oligosaccharin, produced in vitro by acid- or enzyme-catalysed fragmentation of polysaccharides present in the cell walls or derived from pectins, glycoproteins or xyloglucan, or secreted by bacteria of the genus Rhizobium. Other metabolic compounds of biotic origin that have been shown to have an SAR effect are the chitosans, the main constituents of chitin, usable in aqueous solution as described for example in WO 2010/015913.

The present invention proposes to provide a composition for agricultural use, based on natural substances, that induces an SAR (Systemic Acquired Resistance) effect in plants and crops. The aim of the invention is to provide a composition that is effective, safe, of reliable and plannable supply, and free from side-effects both for the environment and for humans.

To achieve these aims, the invention relates to a composition for agricultural use, a method for its preparation and its uses in the treatment of plants and crops, as defined by the claims that follow.

According to a first aspect, a composition for agricultural use is described that comprises a biotic compound derived from microalgae. Preferably, the biotic compound comprises all the original polysaccharides of said microalgae. In other words, for the preparation of the composition, no specific extraction of preferred polysaccharides is carried out, but the entire original content of polysaccharides of the microalgae is used. This results in a process that is simple and economical, yet controlled in its basic parameters.

An advantage of the present invention is that of being able to control precisely and rigorously the natural compounds that produce the resistance induction activity. This is due to the fact that the composition is based on the use of algal extracts derived from microalgae, in particular but not exclusively diatoms and/or cyanobacteria, cultured in a controlled extra-marine environment and especially, although not exclusively, in photobioreactors. The culturing may also take place in other types of containers, such as basins placed in closed environments and with controlled parameters in terms of lighting and temperature. Environments that have proved particularly advantageous are greenhouses and similar protected environments.

According to a particular aspect, a description is therefore given of a composition for agricultural use that comprises a biotic compound derived from microalgae. The microalgae are used in their entirety in the biotic compound after disruption of their cell walls to allow the escape of the polysaccharides contained within the cell. Preferably, the algal mass is used in its entirety in the composition for agricultural use. According to a variant, selected components are extracted from the algal mass. The selected components previously extracted from the mass are preferably pigments.

Preferably, the microalgae are diatoms and/or cyanobacteria. More preferably, the microalgae comprise an algal strain selected from the group comprising Phaeodactylum tricornutum, Arthrospira platensis (Spirulina), Euglena gracilis and Porphyridium cruentum. Still more preferably, the microalgae comprise only Phaeodactylum tricornutum or Arthrospira platensis (Spirulina), or a combination thereof in various proportions. According to a particular aspect, pigments are previously extracted from the algal masses used in the composition for agricultural use. In particular, phycocyanin is previously extracted from Arthrospira platensis. Phycoerythrin is previously extracted from Porphyridium cruentum. In this way it is possible to exploit the algal mass for the manufacture of pigments, which do not affect the induction of plant resistance in plants. The process thus combines simplicity and efficiency of production of a composition that is effective in agriculture for the induction of resistance in plants, with the advantageous production of pigments with high added value in other fields of application, for example the field of cosmetics.

According to a particular aspect, the microalgal extracts of the present invention have a high content of polysaccharides. These include chrysolaminarin, which has been shown to have an important effect in the induction of resistance in plants. The composition may therefore comprise chrysolaminarin. The composition may comprise Beta 1,3-glucans. According to a particularly advantageous aspect, the algal mass used in the composition for agricultural use is used with formulations based on the total content of polysaccharides, regardless of the specific content of glucans and particularly of beta-glucans. It is therefore not necessary to make a specific extraction of beta-glucans, providing an advantage in terms of simplicity and economy of process.

According to another specific aspect, the microalgae are cultured in closed environments with controlled temperature and lighting. The closed environment may be a greenhouse or a photobioreactor.

According to a further aspect, the microalgae have a total content of polysaccharides, in terms of % w/w of biomass, of between approximately 10% and 40%. The total content of polysaccharides in the composition using the algal mass is taken into account for determining the quantity of composition and the frequency of application to the various plant species for effective resistance induction.

According to a further aspect, the microalgae have a content of Beta 1,3-glucans, in terms of % w/w of biomass, greater than 0.5%.

The use of a composition for the induction of plant resistance in agriculture is also described. In particular, the induction of resistance against Plasmopara viticola is described.

According to a particular aspect, a description is given of the application on successive occasions, at different stages of growth of the plants, of compositions containing different percentages of Phaeodactylum tricornutum and/or Arthrospira platensis (Spirulina).

The invention will now be described in detail with reference to a preferred embodiment, to be regarded as a non-limitative example of the variants and possible embodiments of the invention defined in the claims.

### Algal Strain

An algal strain of the species Phaeodactylum tricornutum, of the class Bacillariophyceae, was used. This species is particularly preferred for the invention because by comparison with most of the other diatoms it can also grow at low concentrations of silica. In addition, this species has been shown to have a fast rate of growth and has the feature of accumulating lipids up to approximately 20-30% of its dry weight, with a high omega-3 content. The reserve sugars of Phaeodactylum tricornutum are mostly chains of Beta 1-3/-6 glucans, known as chrysolaminarin, which in natural conditions represent from 10% to 30% of the organic dry weight.

### Maintenance of the Algal Strain

The Phaeodactylum tricornutum strains are stored in a thermostat-controlled chamber at 20° C. with a daily light/dark cycle (16:8 hours) at a lighting intensity of 90-100 μEinstein m⁻²s⁻¹. The culture is maintained in a culture medium (M) at a salinity of 25 psu.

The culture medium used is semi-synthetic, being based on seawater which at the time of use is filtered in a vacuum flask with GF/C glass-fibre filters with a diameter of 90 millimetres and a porosity of 1.2 μm. After measuring the salinity of the seawater, this is corrected by adding demineralised water. The water at the correct salinity is sterilised in an autoclave at 1 bar for at least 30′ Approximately every 15-20 days, the algal strains, after exhausting the nutrients present in the liquid medium, pass from the stationary growth phase to a degrowth phase. In order to conserve the strains, the cultures are periodically inoculated into new media.

The characteristics of the culture medium (M) used are as follows:

TABLE 1
Medium (M)

| | | Quantity of | Final | |
|---|---|---|---|---|
| | Stock | stock in | quantity | Final |
| Components of | solutions | medium | in medium | concentrations |
| medium (M) | (g/L) | (ml) | (g/L) | in medium (M) |
| NaNO₃ | 75 | 1 | 0.075 | 8.82 × 10−4 |
| NaH₂PO₄ | 5 | 1 | 0.005 | 3.62 × 10−5 |
| Na₂SiO₃ 9H₂O | 30 | 1 | 0.030 | 1.06 × 10−4 |
| HEPES (solution | 230 | 1 | 0.230 | 9.65 × 10−4 |
| pH 7.2-7.5) | | | | |
| Selenium | 17 | 0.08 | 0.0014 | 7.86 × 10−6 |
| (Na₂SeO₃) | | | | |
| *Solution of | | 1 | | |
| microelements + | | | | |
| EDTA | | | | |
| **Solution of | | 0.5 | | |
| vitamins (B12, | | | | |
| biotin, | | | | |
| thiamine) | | | | |

TABLE 2
Micronutrients

| | | | | Final | |
|---|---|---|---|---|---|
| *Solution of | Stock | | | quantity | Final |
| microelements + | Solutions | Quantity | | in medium | concentrations |
| EDTA | (g/L) | in soil* | | (mg/L) | in medium (M) |
| FeCl₃ 6H₂O | | 3.15 | g | 3.15 | 1.17 × 10−5 |
| Na₂EDTA 2H₂O | | 4.36 | g | 4.36 | 1.17 × 10−5 |
| MnCl₂ 4H₂O | 180 | 1 | ml | 0.18 | 9.10 × 10−7 |
| ZnSO₄ 7H₂O | 22 | 1 | ml | 0.022 | 7.65 × 10−8 |
| CoC1₂ 6H₂O | 10 | 1 | ml | 0.010 | 4.20 × 10−8 |
| CuSO₄ 5H₂O | 9.8 | 1 | ml | 0.0098 | 3.93 × 10−8 |
| Na₂MoO₄ 2H₂O | 6.3 | 1 | ml | 0.0063 | 2.60 × 10−8 |

TABLE 3
Vitamins

| | | | | Final | |
|---|---|---|---|---|---|
| **Solution of | | | | quantity | |
| vitamins (B12, | Stock | | | in | Final |
| biotin, | Solutions | Quantity in | | medium | concentrations |
| thiamine) | (g/L) | soil** | | (mg/L) | in medium (M) |
| Thiamine * HCl | | 200 | mg | 0.1 | 2.96 × 10−7 |
| (vitamin B1) | | | | | |
| Biotin | 0.1 | 10 | ml | 0.0005 | 2.96 × 10−9 |
| (vitamin H) | | | | | |
| Cyanocobalamin | 1 | 1 | ml | 0.0005 | 3.69 × 10−10 |
| (vitamin B12) | | | | | |

### Growth in Batch Cultures (2-10 L)

A first inoculation of an aliquot of algal suspension of Phaeodactilum tricornutum was made in 1.250 L of new medium (M). For this first phase, the population was made to grow in two 2 L flasks. The two flasks were kept in a thermostat-controlled chamber at 20° C. under approximately 100 μEinstein m⁻²s⁻¹ of light. The cultures in flasks in small volumes, up to 2 L, were maintained without stirring or air insufflation.

After the first phase, both replica cultures, each of 2 L in total, were inoculated into a 10 L sterile bottle containing 6 L of new medium (2 L of inoculum+6 L of medium=8 L total), cultured at ambient temperature (average 23° C.), under 160-200 μEinstein m⁻²s⁻¹ of light. Culturing in larger volumes of 2-3 L required air insufflation and stirring.

### PBR70 Inoculum

On the same day, 4 L of new medium (M) were added to obtain an inoculum capable of starting the culture on a small/medium scale in a vertical photobioreactor (PBR70) with a total volumetric capacity of 70 L.

Subsequently, a culture of Phaeodactylum tricornutum was started in PBR70 with a total volume of 60 L. The initial conditions of the inoculum and the PBR70 were as follows:

TABLE 4
Parameters of the batch culture of 9-10 L of Phaeodactylum tricornutum
used as inoculum for the PBR70.

| | |
|---|---|
| Abundance (cells/ml) | 2.14*106 |
| Dry weight (g/L) | 0.49 |
| Medium | M |
| Temperature ° C. | 20 |
| Salinity (psu) | 25 |
| μEinstein m−2 s−1 | 100 |
| Light/dark cycle: | 16.8 |
| Culture pH | 9.4 |

TABLE 5
Initial parameters of the culture of the PBR70
photobioreactor containing approximately 60 L.

| | |
|---|---|
| Dry weight (g/L) | 0.20 |
| Medium | M |
| Temperature ° C. | 23 |
| Salinity (psu) | 25 |
| μEinstein m−2 s−1 | 230 |
| Light/dark cycle | 16:8 |
| Culture pH | 9.11 |
| Flow of air/CO₂ mix (L/min) | 4 |
| % CO₂ | 0.5 |
| pH control with CO₂ flow | 8.5 |

### PBR70 Results

### Growth in PBR70 Experimental Photobioreactors

After 22 days from the start of the culture in the PBR70, approximately 60 litres of final culture were collected. The chemical/physical (pH and uptake of nutrients) and biological parameters were monitored to control the dynamics of the algal growth. The final culture was used to produce a formulation with extract of Phaeodactylum in order to carry out tests on plants and crops.

### pH Variability

The pH may undergo substantial variations during the course of culturing. These variations are normalised during growth by controlled regulation of the CO₂ insufflation, which indirectly regulates the pH of the culture.

### Consumption of Macronutrients

During the course of the culture, the nutrient consumption was exponential. During the course of the culture, additions were made to return N and P to the initial concentrations of the medium over the days. Measurement of the concentration of nutrients, performed the day after the addition, showed their rapid assimilation. Careful monitoring of the consumption of nutrients by part of the culture of Phaeodactylum tricornutum is useful and used to identify both the optimal trophic conditions and those that optimise the productivity of specific molecules involved in the formation of the composition of the present invention.

### Concentration of Cellular Sugars (Chrysolaminarin) in the Culture

The reserve sugars of Phaeodactylum tricornutum are mostly chains of Beta 1-3/-6 glucans, known as chrysolaminarin, which represent from 10% to 30% of the organic dry weight. The measurements performed of the concentrations of cellular sugars indicated a value of approximately 11% with respect to the dry weight.

### Collection of Biomass

### Collection on Disc Filter

2.65 L were taken for a biomass collection test. A vacuum filtration system was used, through a glass-fibre filter (Millipore AP4014250 0.7 micrometre, 142 mm diameter) which collected the entire volume.

TABLE 10
Biomass recovery after filtration using
0.7 μm Millipore AP4014250 filters.

| | Vol | Total dry | Dry | |
|---|---|---|---|---|
| | (L) | weight (g) | weight | % recovery |
| Total | 2.65 | 1.298 | 0.49 | |
| biomass | | | | |
| Filtrate | 2.65 | 0.371 | 0.14 | 28 |

### Flocculation Test

A flocculation test was performed using the culture that showed a dry weight of approximately 1 g/L. With a basic 1M solution of KOH (5.16 g/100 mL), the pH was raised to 2 different levels and a measurement was made of the compaction of the algae in 100 mL cylinders after 17 hours. A third cylinder with the unmodified culture served as a reference for estimating the normal sedimentation of Phaeodactylum tricornutum due to gravity.

The flocculation procedure proved to be an optimal method for the collection of microalgae.

### Collection and Analysis of Biomass

The PBR70 biomass was collected by centrifugation in 250 mL plastic containers at 8000 rpm for 15-20′. In two days, approximately 60 L of culture were collected, and two treatments to reduce the percentage of salts in the final formulation were tested:
1) 83.62 g in fresh weight (FW) were collected as such and frozen at −20° C.
2) The remaining 71.70 g in fresh weight (FW) were returned into suspension with distilled water (72.2 g distributed in 6×250 mL vials) and then collected and frozen at −20° C.

Both of the centrifuged pellets, left as such, were resuspended in 100 mL of a buffer solution for storage (formulations).

The microalgae extracts were compared with a commercially available comparator product (CP), obtained from microalgae harvested directly from the sea. The comparator product CP has been used for some time as a resistance inductor.

The microalgae extracts showed a less acid pH than the comparator product CP. In addition, the microalgae extract according to the invention has a markedly lower sodium content than the comparator product, which has a sodium content 10 to 30 times greater than the extract of the invention. It is worth noting at this point that sodium is highly toxic to plants.

### Polysaccharide Extraction Methods

The methodology used for bringing the polysaccharides contained in the biomass of Phaeodactylum tricornutum into solution was applied using various methods. Verification of cellular lysis was performed optically by microscope.
1. Various cycles of freezing the pellets and formulations at −20° C. (at least three cycles).
2. Acid extraction by the addition of 0.1 Molar sulphuric acid at pH 5.
3. Three cycles of sonication in ultrasound baths at ambient temperature for 5′ with standard probe on the XL2020 Heat Systems sonicator.
4. Warm bath at 54° C. for 4 hours.

### Emulsifiers, Preservatives and Stabilisers

No emulsifiers were added to the final formulations, although the possibility is not excluded of using co-formulants that bring into solution, preserve and stabilise the compounds produced.

Field Tests of the Formulations Derived from Phaeodactylum tricornutum

Dilution rates for the Phaeodactylum tricornutum formulations were proposed in order to obtain a specific concentration of total polysaccharides and an extremely low sodium content, which are the two main variables in manufacturing the product used for agricultural use.

The Phaeodactylum tricornutum formulations were diluted so as to obtain a sugar concentration of 0.0526 g/l, matching the concentration of the comparator product (CP).

At this dilution, the sodium content of the Phaeodactylum tricornutum formulations was approximately one half (0.007 g/l) to approximately one third (0.004 g/l) of that of the comparator product (0.013 g/l).

The field tests were performed on vine plants affected by peronospora. The potential of certain biocontrol and plant extract products for protection against Plasmopara viticola (peronospora) was also assessed, since some chemical and natural substances can reduce the plants' susceptibility. In particular, comparisons were performed on the use of commercial products or experimental products:
EXPERIMENTAL PRODUCT 1 (EP1) yeast extract
EXPERIMENTAL PRODUCT 2 (EP2) plant extract
EXPERIMENTAL PRODUCT 3 (EP3) Aureobasidium pullulans
CANG extract of Solidago canadensis
P E N extract of mycelium of Penicillium crysogenum
LIN linoleic acid
BABA—chemical elicitors of 3-dl-β-aminobutyric acid
BTH—chemical elicitors of benzothiadiazole
CP—comparator product: extract of microalgae
MBGPT1—alginate extract of Phaeodactylum tricornutum obtained according to the method described above
chrysolaminarin from microalga

The efficacy of the treatments using the products listed above was assessed on the basis of the induced resistance using foliar discs and potted vine plants. The rate of induced resistance was determined on the basis of the increase in the content of pathogenesis-related (PR) proteins including: peroxidase, polyphenoloxidase, Beta 1,3-glucanase, phenylalanine ammonia-lyase, stilbene synthase, PR-1 protein and caffeoyl coenzyme A-3-O-methyltransferase.

The findings were as follows:
BABA, BTH, CanG and MBGPT1 provided protection of more than 80%, while PEN, LIN, EP3 and CP provided insignificant protection;
BABA and EP3 were unable to inhibit the zoospores, while an inhibition of the mobility of the zoospores, due to their concentration, was observed for all the other substances examined;
BTH, CanG, PEN, LIN and MBGPT1 induced the production of a wide range of metabolites linked to resistance phenomena;
EP3 did not produce any response;
BABA and MBGPT1 caused the formation of necrotic spots and PR proteins immediately after inoculation.

These results indicate the potential for resistance induction provided by the product MBGPT1 according to the present invention, for improving the tolerance of vine plants to Plasmopara viticola.

### Formulations for Resistance Inductors

Having obtained the first results from the field tests, in order to assess the potential of various cultured algal species in the field of resistance inductors, species-specific protocols were optimised and characterisation analyses in terms of total polysaccharides were conducted. In addition, quantitative measurements were made of Beta 1,3-glucans, which are thought to be responsible for inducing PR proteins dedicated to resistance to attack (SAR).

### Preparation of the Biomass

Various algal species were cultured: in addition to the already mentioned Phaeodactylum tricornutum (PT), Arthrospira platensis (Spirulina) (SP), Euglena gracilis (EG) and Porphyridium cruentum (PC) were cultured in useful quantities for an initial characterisation.

Arthrospira platensis (Spirulina)

The batch of Spirulina used was cultured in a basin in a greenhouse. The biomass was collected by filtration and frozen at −20° C. Phycocyanin was extracted from the biomass. The remaining biomass, after extraction of the phycocyanin (approximately 80 g fresh), was frozen at −20° C.

Phaeodactylum tricornutum

Phaeodactylum tricornutum was cultured in photobioreactors using the methodology described above, and was collected by continuous-flow centrifugation. The biomass was collected with two different centrifuges. With a manual centrifuge, the biomass showed a rather low moisture percentage, and was used for the formulations PT-A, PT-D and PT-E. With an automatic centrifuge, the biomass showed a high percentage of water. The biomass obtained from this collection was centrifuged again to lower the percentage of water and was used for the formulations PT-B and PT-C.

Small aliquots (5 g dry weight—DW) of the two collections were used for the characterisation of the biomass in terms of total polysaccharides. In addition, the lyophilised samples were maintained at −20° C. for analysis of lipids and proteins. The biomass (approximately 450 g total fresh weight) was stored at −20° C. until the time of its use for the preparations.

Euglena gracilis

Euglena gracilis was cultured in 3×2 L bottles for a total of 6 L of culture. The biomass was collected by benchtop centrifuge at 800 mL every 20 min, and lyophilised to a total dry weight of 8.5 g. Of this quantity, 2.4 g were used for quantification of the polysaccharides of the biomass, while the remaining 6.1 g were frozen at −20° C. and used for the preparation of the EG formulation. The production of Euglena gracilis was carried out in small volumes for an initial characterisation. The culturing of Porphyridium cruentum was also carried out in small volumes for an initial characterisation.

### Characterisation

The algal biomass of the different cultured species was characterised in terms of total polysaccharides and Beta 1,3-glucans (Table 1).

TABLE 1
Biomass content of polysaccharides and Beta 1,3-glucans % w/w.

| | Total | Beta 1,3- |
|---|---|---|
| Cultured species | polysaccharides | glucans |
| Arthrospira | 13.8% | 1.0% |
| platensis | | |
| Euglena gracilis | 16.6% | 1.1% |
| Phaeodactylum | 12.1% | 0.5% |
| tricornutum | | |
| Porphyridium | 37.5% | 3.9% |
| cruentum | | |

### Preparation of the Formulations

The algal biomass was subjected to two cycles of thawing (at ambient temperature) and freezing (−20° C.). A phosphate buffer was used to maintain the formulations at a constant pH during processing. This buffer was chosen because it is found in the internal fluid of all cells, and the addition of elements such as potassium and phosphorus are elements useful to the plants at the time of the distribution of the product. This buffer consists of H₂PO₄⁻, which acts as a donor of H⁺ ions (Bronsted-Lowry acid), and the hydrogen phosphate ion HPO₄²⁻, which acts as an acceptor of H⁺ ions (Bronsted-Lowry base)

In particular, for the preparation of the phosphate buffer, a mixture was made of K₂HPO₄ 0.1M (17.41 g L⁻¹) and KH₂PO₄ (13.6 g L⁻¹) to a pH of 7.2-7.3 (N.B. The proportions are approximately ¼ KH₂PO₄ and K₂HPO₄).

Aliquots with a fresh weight of 100 g L⁻¹ were dissolved in 200-230 mL of phosphate buffer or in H₂O (to verify the effect of the buffer on the preparation of the formulation and on the plants).

The samples were subjected to acidification with H₂SO₄ and various thermal treatments, in terms of duration and temperature, using the methods used for the formulations prepared and tested as described previously and the methods commonly used for the extraction of total polysaccharides (Mykelstad) and Beta 1,3-glucans. The choice was made to use an acidification with H₂SO₄ so as to have sulphur in the formulation instead of chlorine, and so as not to increase the salinity of the preparation. In addition, H₂SO₄ has a final molarity in the formulation of 0.05 M, keeping the molecules of Beta 1,3-glucans intact.

TABLE 2
Conditions used for the preparation of the various formulations

| Formulation | | Acidification | Incubation | Incubation | |
|---|---|---|---|---|---|
| ID | Solution | H₂SO₄ | temperature | time | |
| MBG-SP- | Phosphate | 0.05M | 60° C. | 2 | h |
| 0315 | buffer | | | | |
| MBG-EG- | Phosphate | 0.05M | 60° C. | 2 | h |
| 0315 | buffer | | | | |
| MBG-PT- | Phosphate | 0.05M | 100° C. | 2 | h |
| A0315 | buffer | | | | |
| MBG-PT- | In water | — | 60° C. | 2 | h |
| B0315 | | | | | |
| MBG-PT- | Phosphate | — | 60° C. | 2 | h |
| C0315 | buffer | | | | |
| MBG-PT- | Phosphate | 0.05M | 60° C. | 4 | h |
| D0315 | buffer | | | | |
| MBG-PT- | Phosphate | 0.05M | 60° C. | 20 | min |
| E0315 | buffer | | | | |

From each formulation, aliquots (10 mL) were taken for determination of the dry weight, concentration of polysaccharides and pH after the various treatments applied (Table 3). Each formulation was refrozen at −20° C. and can be used for distribution using Table 3 for the dilutions to be made in order to maintain the concentration of total polysaccharides present in the comparator product CP obtained from macroalgae, during distribution for the field tests.

TABLE 3
Characterisation of the final formulations and relative dilutions for distribution

| | TOT | Dry | | | | Polysaccharides | Final |
|---|---|---|---|---|---|---|---|
| Sample | Vol | weight | | Polysaccharides | | in distribution | treatment |
| ID | mL | g L⁻¹ | pH | g L⁻¹ | Dilution | g L⁻¹ | volume |
| Comparator | 1000 | 474.8 | 4.25 | 70.3 | 1300 | 0.054 | 1300 |
| Product CP | | | | | | | |
| MBG-SP- | 200 | 63.4 | 4.25 | 5.6 | 100 | 0.057 | 20 |
| 0315 | | | | | | | |
| MBG-EG- | 90 | 48.9 | 5.28 | 5.1 | 90 | 0.056 | 8 |
| 0315 | | | | | | | |
| MBG-PT- | 200 | 59.1 | 4.76 | 6.2 | 110 | 0.056 | 22 |
| A0315 | | | | | | | |
| MBG-PT- | 200 | 181.6 | 7.23 | 7.0 | 130 | 0.054 | 26 |
| B0315 | | | | | | | |
| MBG-PT- | 200 | 115.3 | 8.70 | 6.8 | 120 | 0.056 | 24 |
| C0315 | | | | | | | |
| MBG-PT- | 200 | 50.9 | 4.32 | 5.6 | 100 | 0.056 | 20 |
| D0315 | | | | | | | |
| MBG-PT- | 200 | 69.3 | 4.38 | 5.6 | 100 | 0.056 | 20 |
| E0315 | | | | | | | |

The centrifugations performed result in a partial disruption of the cells, to a greater extent if the biomass has already been subjected to freezing cycles or treated for other extractions. Since this means that part of the polysaccharide material may end up in the supernatant, it is useful to recover the supernatant rather than discard it, so that it too can be used as a resistance inductor. This is particularly advantageous for those algal species whose culture medium has a low salinity.

As regards the homogeneity of the formulations, in some cases it was observed that solid residues remained inside the mixtures. This could make it difficult to emulsify the formulation in water for distribution. In this event, if it proves difficult to adequately emulsify the formulation, a centrifugation of the mixture can be performed in order to use only the supernatant.

In the case of production runs in greater quantities than those carried out in the laboratory tests, it is appropriate to use faster and more efficient extraction methods, for example using a continuous-flow centrifuge of the type generally known to a person skilled in the art.

### Extraction of Phycocyanin

As mentioned previously, from the algal mass used for the formulation of the composition for agricultural use it is possible to extract components that apparently have no substantial effect on the induction of resistance in plants. One example of such components are pigments, for example phycocyanin from Arthrospira platensis and phycoerythrin from Porphyridium cruentum.

Extraction of Phycocyanin from Dry Biomass

In the experiments performed in order to extract phycocyanin from the algal mass of Spirulina, mechanical cell disruption methods were used, since these are more economical than enzymatic disruption methods.

The biomass of Spirulina was washed to eliminate the salts present in the culture medium. The biomass was then lyophilised.

The extraction was carried out by mechanical crushing. It is possible to use cycles in liquid nitrogen to force the disruption of the cells during mechanical crushing. On completion of the crushing process, an extraction solvent was added, normally a phosphate buffer, in order to transfer the biomass from the crushing mortar to a graduated cylinder for verification of the results. Phycocyanin corresponds to approximately 10-15% of the Spirulina, therefore up to 100-150 g of phycocyanin can be obtained from 1 kg of biomass. After extracting the phycocyanin by mechanical crushing, the homogenate was kept on ice and in the dark between one purification stage and the next.

Phycocyanin Purification

The first purification was carried out by means of a centrifugation process, in order to precipitate the whole biomass in more Spirulina. The solution of Spirulina and solvent was subdivided into 50 mL Falcon tubes and centrifuged at 4000 rpm for 30 min at 4° C., then the supernatant was filtered with GF/C filters 90 mm in diameter. This first purification process eliminated the heavier and larger components in the cells that cannot be extracted in water (lipids, fibres, membranes and organelles). In the filtrate were retained, along with the phycocyanin, different concentrations of chlorophyll (depending on the degree of extraction performed), polysaccharides and all thylakoid proteins and cellular proteins in general. At this point, readings were taken to measure the extraction yield and the purity of the extract. The absorbance readings showed that the best ratio between dry biomass (mg) and solvent volume (ml) in terms of extracted phycocyanin (CP mg/ml) is around 15:1-20:1. In terms of phycocyanin yield extracted per gramme of biomass, higher values are obtained with the aid of liquid nitrogen in the mechanical crushing process, which allows better disruption of the cells.

### Second Stage of Phycocyanin Purification

The purification of the phycocyanin was subsequently improved using ammonium sulphate. Experiments were performed at different concentrations of ammonium sulphate, in particular by using different concentrations and different saturations. It was found that the highest degree of purity is obtained by immediately introducing large quantities of ammonium sulphate, at a level of approximately 60%. However, the highest yield is obtained by dissolving approximately 10% of ammonium sulphate, so as to precipitate only part of the chlorophyll and proteins present. A further stage with ammonium sulphate makes it possible to achieve a purification greater than 1.

### Third Stage of Phycocyanin Purification

Further processes of purification of the molecule were tested using dialysis systems for the removal of ammonium sulphate salts and using ion-exchange chromatography. In particular, dialysis was carried out on samples of 50 ml (previously treated with different concentrations of ammonium sulphate), using distilled water as exchanger. The process was kept at 4° C. to prevent degradation of the phycocyanin. The water was changed every hour for a total of 2 or 4 hours. The membrane used was a 14000 Dalton dialysis membrane.

It was found that dialysis, after two hours, has no effect on the purity of the biomass, but helps to eliminate the salts used for purification, such as ammonium sulphate. The chromatography stage does not produce any change in terms of purity compared with that obtained after the ammonium sulphate stage.

Naturally, without prejudice to the principle of the invention, the embodiments and the details of implementation may vary widely with respect to what is described and illustrated here, without thereby departing from the scope of the present invention.

1. A composition for agricultural use, comprising a biotic compound derived from microalgae that comprises all the original polysaccharides of said microalgae.

2. Composition according to claim 1, wherein the microalgae are diatoms and/or cyanobacteria.

3. Composition according to claim 1, wherein the microalgae comprise an algal strain selected from the group comprising Phaeodactylum tricornutum, Arthrospira platensis (Spirulina), Euglena gracilis and Porphyridium cruentum.

4. Composition according to claim 1, wherein the microalgae comprise exclusively Phaeodactylum tricornutum and/or Arthrospira platensis (Spirulina).

5. Composition according to claim 1, comprising polysaccharides.

6. Composition according to claim 1, wherein the microalgae are cultured in closed environments with controlled temperature and lighting.

7. Composition according to claim 6, wherein the closed environment is a greenhouse.

8. Composition according to claim 6, wherein the closed environment is a photobioreactor.

9. Composition according to claim 1, wherein the microalgae have a total content of polysaccharides, in terms of % w/w of biomass, between approximately 10% and 40%.

10. Composition according to claim 1, wherein the microalgae have a total content of Beta 1,3-glucans, in terms of % w/w of biomass, greater than approximately 0.5%.

11. Use of a composition according to claim 1 for the induction of plant resistance in agriculture.

12. Use according to claim 11, for the induction of resistance against Plasmopara viticola.

13. Preparation of a composition according to claim 1, comprising the preparation of an algal mass derived from microalgae and crushing of the algal mass.

14. Preparation of a composition according to claim 13, comprising the extraction of pigments from the algal mass.

15. Preparation of a composition according to claim 13, wherein the complex of polysaccharides contained in the algal mass is essentially maintained entirely in the composition for agricultural use.
